(19) United States
(12) Patent Application Publication
(10) Pub. No.: US 2017/0264729 A1
(43) Pub. Date: Sep. 14, 2017

(54) Accessory-style wireless audio communications system and associated devices, methods and apparatuses.

(71) Applicant: Linda Christine Cavalli Nelson, REDMOND, OR (US)

(72) Inventor: LINDA CHRISTINE CAVALLI NELSON, REDMOND, OR (US)

(21) Appl. No.: 15/454,569

(22) Filed: Mar. 9, 2017

Related U.S. Application Data
(60) Provisional application No. 62/352,407, filed on Jun. 20, 2016.
(60) Provisional application No. 62/305,932, filed on Mar. 9, 2016.

(51) Int. Cl. H04M 1/60

(52) U.S. Cl. CPC H04M 1/6066; H04M 2250/02

(57) ABSTRACT

The present invention consists of an accessory-style wireless audio communications system and the associated devices, methods and apparatuses for providing the convenience and functionality of wireless audio communications in a variety of exchangeable fashion accessory styles. The invention comprises a specially designed accessory-style wireless audio communications device; various fashion accessory-style apparatuses; and various methods for combining the wireless audio communications device and one or more of the accessory apparatuses. By integrating the mobile, hands-free convenience of Bluetooth and other wireless audio technologies with the look of desirably wearable fashion accessories, the invention allows users, and particularly female users, to maintain discrete access to their mobile phones and other connected devices without having to carry the devices directly on their persons or wear unbecoming and otherwise undesirable headsets or earpieces. The slimline style of the wireless audio communications device and the diverse form factors of and methods for the accessory apparatuses allow users to achieve multiple accessory looks with a single wireless audio device. This includes the use of neck-, ear- and eye-based accessory apparatuses that have been specifically designed for invention device, as well as certain types of a user's own personal accessories. The invention also integrates a number of different hardware, software and application features that allow users to control from the wireless audio communications device multiple convenient features and functions that are either not currently available in other mobile audio devices or that users would otherwise require multiple devices to access.

This application claims priority under 35 U.S.c.§119(e) from Provisional Patent Application No. 62/305,932, filed on Mar. 9, 2016, and Provisional Patent Application No. 62/352,407, filed on Jun. 20, 2016, the contents of both of which are incorporated herein by reference.

### BACKGROUND OF THE INVENTION

1. Field of the Invention

The present invention relates generally to a system and the associated devices, methods and apparatuses for integrating and otherwise combining a wireless audio communications device in a variety of wearable accessory styles.

2. Background

Mobile hands-free audio communication devices such as Bluetooth® wireless earphones offer multiple health, safety, productivity, convenience, access and mobility benefits. For example, mobile Bluetooth earphone devices: emit less than one one thousandth ( 1/1000) of the radiation emitted from the typical mobile phone; do not contribute to neck and shoulder strain as compared to holding a mobile phone to the ear for periods of time; free up a user's hands for other activities, thereby increasing productivity and convenience; increase mobility, convenience and access by allowing users to be some distance away from their connected devices; and so forth.

[Note: The term “earphone” and its derivatives are used here and throughout this document to refer to all mobile audio peripheral systems, devices and apparatuses for sending and receiving transmissions to and from other devices such as mobile phones, tablets, computers, streaming devices, smart speakers, and the like. Thus, unless specifically noted as otherwise, the term earphone and its derivatives may be used in this document and its supporting documentation to refer to mobile audio systems, devices and apparatuses referred to herein and elsewhere as earbud(s), headset(s), earpiece(s), hearable(s), audio wearable(s) and the like. The term “wireless” refers primarily to Bluetooth technology, but is intended to also include other applicable wireless technologies.]

Currently there are a number of solutions for wireless earphones. These include Bluetooth earpiece-style devices that are typically worn continuously inserted in one ear; and Bluetooth neckband-style headsets that sit around the neck, with earphones continually inserted in some models, and inserted as needed in other models. However, among other deficiencies, these solutions fail to meet the needs of significant numbers of users with respect to: desirable device design, desirably wearable form factors and materials; style versatility; effective and robust voice-controllable functionality; and user-friendly, -enabling and -relevant device and application interfaces. The magnitude and cumulative effect of these deficiencies is reflected in the relatively low adoption rates of wireless earphone technology by the more than 200 million US mobile phone users.

The deficiencies of existing Bluetooth and other wireless earphone solutions are particularly notable with respect to women mobile phone users. While existing wireless earphone solutions have the potential to address mobile phone access-, mobility-, and health-related issues, they do not resolve the important appearance, or fashion, issue for the majority of women. Because appearance is often a dominant consideration for women, relatively few female mobile phone users avail themselves of existing wireless earphone technology outside of recreational use. As a result, the majority of women often find themselves without convenient and discrete access to their mobile phones during the course of their daily lives—thereby undermining their productivity and availability to others. In addition, conventional mobile phone use also creates health and safety issues: for users if they are holding a mobile phone to their ear for long periods of time, and for both users and others if users are multi-tasking while holding a mobile phone.

In sum, a predominant concern for their appearance and “look” (in terms of fashion and style) is a very significant hindrance to the adoption of wireless earphone technology for large numbers of women. Current Bluetooth earphone solutions fail to meet the needs of the majority of women mobile phone users because they do not complement these user's sense of fashion and style.

A few solutions have been presented that attempt to increase women's access to their mobile phones in a fashion accessory-style form factor. However, none of these solutions effectively meets the communication and access needs of the majority of women mobile phone users. For example, some existing solutions provide wrist-based or finger-based notifications of phone calls and messages, but provide no means for the user to respond to a call or message without having to find and use her phone. More recent smart watch solutions provide cellular functionality but require the user to “talk to her wrist”, which behavior is viewed as functionally inconvenient and/or socially undesirable by the majority of women. Some other solutions attempt to hide an earphone in an accessory-style device, but inconveniently require hand use and dexterity to disassemble the device to access the earphone. These latter solutions also do not provide two earphones for superior sound and/or noise cancelling. Moreover, they do not lend themselves to discrete and convenient use in a social or business setting. Some more recent solutions provide for the use of two small in-ear earphones. However, the deficiencies of these devices include inadequate battery lives, shorter ranges, complicated user settings and controls, and variable audio qualities relative to larger Bluetooth earpieces and neck-based headsets. Many women users also have a strong aversion to having to continually wear one or more devices in their ears in order to receive desired notifications.

Current solutions also don't include an additional speaker assembly in the body of the device, which provides users with the option of receiving audio communications without the use of earphones.

Above all, none of the available solutions provide women with what the majority want and need: the ability to affordably and discretely integrate their wireless technology with a variety of fashion looks and styles to meet their changing and individual needs and whims. Most women do not want to: look like they are wearing technology; wear the same accessory day in and day out; and/or wear the same accessory as other women around them. These women value beauty, they want variety, they want to express their own unique styles, and they want their accessories to change with their fashion needs and moods. Even assuming that an attractive and versatile accessory-style wireless audio system was available (which, currently, it is not), many women cannot afford to buy multiple technology devices for multiple fashion needs and moods. There therefore exists a need for a Bluetooth or other wireless audio communications system that can be integrated and/or otherwise easily combined with diverse accessory styles and designs to allow women to express their individual sense of beauty and fashion in an affordable and convenient way. And there exists a need for the devices, methods and apparatuses to affordably facilitate such integration and diversity of expression.

It would therefore be desirable for users and particularly female users to be able to maintain discrete, mobile and hands-free access to their mobile phones and other Bluetooth-enabled technology devices without having to: constantly carry their devices in a pocket or hand, compromise their individual fashion sense with an unbecoming electronic accessory, and/or otherwise overtly call attention to their technology. It would be desirable for this discrete, mobile and hands-free access to include integrated features and functionality, including but not limited to: phone, messaging and other notification control and use; convenient access to audio caller ID, audio messaging and notifications, and phone calls; the ability to discretely respond to and initiate calls and messaging without having to locate and overtly use one's mobile phone; and the like. It would further be desirable for this discrete, mobile and hands-free access to be in the style of an attractive fashion accessory similar to those the user already wears or desires to wear—and that doesn't look “geeky” and/or similar to what many other users are wearing. It would also be desirable for this discrete, mobile and hands-free access to be adaptable to a wide variety of user styles, tastes, needs and budgets.

It would also be desirable if this discrete, mobile and hands-free access did not require the user to continually look down at the associated device to access its features, and if it did not require significant hand-use and dexterity. If would also be desirable if the touch controls were simple and few, so that the user could quickly learn and use the device to meet her needs without having to learn, manage and remember complicated settings, controls and/or technologies. It would also be desirable if the device allowed for quality phone communications, as well as for quality media streaming with stereo sound and audio.

It would further be desirable if this wireless audio system allowed a user to easily switch between the superior battery life, range, ease of use, and/or audio quality benefits of a wireless audio device with two wired earphones; and the discretion, aesthetics, convenience and other benefits of one or more accessory-style wireless earphones having an independent power source.

It would also be desirable if this discrete, mobile and hands-free access provided the user with other convenient features such as: voice control, including of multiple digital assistants; and the ability to shut a connected mobile phone's ringer off remotely if it rings at an inopportune time and the user is unable to immediately access her phone to silence the ringer directly. It would also be desirable if this discrete, mobile and hands-free access included Emergency Alert Features via a simple touch or voice control or command, so the user can immediately and easily notify authorities and other contacts of her situation and location. It would also be desirable if the user could easily integrate other applications she already uses or would desire to use, so that she could access and use these applications easily from the wireless audio communications device—for example, with respect to social media, calendaring and time management, fitness and health monitoring, emergency alert protocols, contact management, and other life management tools.

It would also be desirable if this discrete, mobile and hands-free access could be provided in a flexible form factor that would allow a user to easily and affordably change the look and style of the device when desired.

To these ends, it would be desirable to have a slimline Bluetooth or other wireless audio communications device suitable in size, design and appearance for integrating and/or otherwise combining with attractive neck- and head-based fashion accessories such as necklaces, scarves, sunglasses and other eyeglasses so as to provide the user with convenient and easy audio access to her mobile phone and other Bluetooth-enabled devices via earphones, which earphones may be wireless (having their own secondary power source) or connected by wires to the wireless audio device. It would also be desirable to have certain hardware and accessory-style apparatuses, elements and methods that facilitate integration of this wireless audio device, and other suitable audio devices, with: various necklace, scarf, ear-based and eye-based apparatuses and elements specifically designed for the audio device; and with certain of a user's own personal necklace, scarf, ear-based and eye-based accessory elements. It would also be desirable if a user could easily integrate and/or otherwise combine the audio device with a number of different accessory looks and styles as needed to complement her current outfit, whim or need.

It would also be desirable for the audio device hardware, software and user interface to allow for haptic notification of calls, messages, reminders and other notifications; and voice control, audio caller ID and audio message readback to maximize the user's discrete, mobile and hands-free access to her mobile phone and other connected devices. It would also be desirable if the user could easily block calls and messages while in certain business and social situations, while still allowing through calls and messages from priority contacts such as children, spouse and other priority individuals. It would further be desirable for the audio system to include an Emergency Alert Feature, to allow a user to immediately notify authorities and/or her selected contacts of her situation and location with a simple touch- or voice-controlled signal from the audio device. It would also be desirable if the user could immediately shut off her mobile phone's ringer from the wireless audio device. It would also be desirable if the User could make the phone ring from the audio device, to assist her in locating her phone if needed. It would further be desirable for all of these features and functionality to be integrated in one single wearable audio communications system that can be integrated or otherwise combined with a wide variety of accessory looks to suit each user's individual style and needs.

It would also be desirable for the wireless audio communications system to optionally include a fitness tracking feature to further increase the device's functionality and reduce the number of additional devices a user needs to purchase and wear.

There therefore exists a need for the system, devices, methods and apparatuses needed to allow for an accessory-style wireless audio system that can meet the diverse and changing style needs and/or desires of women mobile phone users. This includes a need for an accessory-style wireless audio device capable of being easily integrated and/or otherwise combined with multiple different accessories in the style of various neck- and head-based accessories such as necklaces, scarves, ear cuffs, sunglasses and eyeglasses. This also includes a need for the methods and apparatuses needed to accomplish such integration and/or combination in conjunction with: neck-based, ear-based and/or eye-based elements designed specifically for the accessory-style wireless audio device; and/or with certain of a user's personal accessories; and/or some combination thereof.

There is also a need for the wireless audio device hardware, software and accompanying user interface(s) that: increase the user's discrete, mobile and hands-free access to her mobile phone with haptic notification, voice control, and audio caller ID and message read-back; allow her to set priority contacts so that she can always be available to certain important contacts while still limiting her incoming calls and messages in certain situations and environments; allow her to immediately shut off her mobile phone ringer from the wireless audio device; increase her safety with a touch- and/or voice-controllable wireless audio device-based emergency alert feature; allow her to locate her connected mobile phone from the wireless audio device; alert her if she moves out of range of her connected mobile phone; optionally increases her access to fitness tracking features without her having to purchase and/or wear multiple devices; and allow her to control from the wireless audio device other life management, social and business applications that she already uses or would otherwise desire to use.

### SUMMARY OF THE INVENTION

The present invention advantageously addresses the aforementioned deficiencies and satisfies the identified needs by providing the devices, methods and apparatuses for integrating and/or otherwise combining the functionality of a Bluetooth or other wireless audio communications system with the desirable look and style of various neck-, eye- and ear-based fashion accessories, including the ability to create multiple accessory looks with one wireless audio communications device.

The basic version of the invention includes an accessory-style wireless audio communications device, certain accessory apparatuses, and certain methods for combining the wireless audio communications device with one and/or more accessory apparatuses. The basic invention device is an accessory-style, neck-based Bluetooth audio communications device consisting of two accessory-style earphones connected by accessory-style earphone wires to the wireless audio communications device; two slimline subcomponent packages containing the hardware, software, battery, charging port, user controls and other components necessary for wireless audio communications device functionality and features; an additional speaker assembly contained in one or more of the subcomponent packages (additional to the speaker assemblies in the earphones); two accessory-style earphone docking elements; and an accessory-style device wire that connects the subcomponent packages and earphone wires. The user controls and battery charging ports are provided on the bottom and sides of the subcomponent packages. The device wire, earphone wires, earphones, subcomponent packages and earphone docking elements include decorative design and material elements that give them an accessory-like look. They also include magnetic and/or magnet-attracting materials, and other functional elements and materials, that facilitate integration and/or other combination of the wireless audio communications device with the accessory apparatuses and/or with certain of a user's personal accessory elements.

In the basic version of the invention, the accessory apparatuses include a necklace element that connects to each end of the wireless audio communications device to create a full necklace-like circle. An earphone docking element attached to the bottom of each subcomponent package provides a place for the respective earphone to dock and integrate with the overall accessory look, while still being conveniently available to the user when needed. The necklace element has a hook, clasp, magnetic and/or other easy-release fastener on one or both ends, so that the user can easily remove and attach the combined accessory-style wireless audio system from the front.

In some variations, the accessory apparatus is a scarf-like element that covers all or part of the wireless audio communications device. The design fastens around and/or otherwise to the wireless audio communications device in such a way that allows for easy removal and exchange of the scarf-like element, and includes design elements that allow for convenient access to one or more earphones and needed user controls. In the basic version of this variation, these design elements include a special wireless audio communications device casing that is sewn into or otherwise attached to the scarf-like element. The means for fastening the wireless audio communications device casing around or to the wireless audio communications device include one or more of the following: Velcro, other adhesive materials, snaps, buttons, zippers, hooks, clasps, other fasteners, ties, seams, and/or magnetic and magnet-attracting materials and/or elements, such that the casing can easily be opened and closed around the wireless audio communications device. When the wireless audio communications device casing is closed around the wireless audio communications device, an opening at the top allows for exit of the earphone wires, if any. The wireless audio communications device casing may also include one or more earphone docking elements, and one or more slots and/or other access points for one or more of the respective subcomponent packages to be secured and otherwise available, such that needed wireless audio communications device controls are conveniently accessible. Alternatively, there may be one or more accessory-style elements on the casing or scarf element that encloses and/or otherwise affixes to the respective subcomponent package, which accessory-style element(s) may include accessory-style earphone docking elements. The latter element(s) may be affixed to a bendable wire and/or other adjustable device, such that the arrangement of the respective subcomponent package and earphone can be manipulated by the user to optimize her access to the wireless audio communications device and system according to her accessory style and user preferences.

The invention may also include certain accessory apparatuses and methods that provide users with optional means and methods for integrating the wireless audio communications device with certain of their own personal accessories. Such accessory apparatuses may be in the form of a pin or brooch, a bobby-pin like clip, a clip with interlocking or otherwise connecting teeth, a ring (closed or open), a clamp, a clasp, a coil, a spiral, a chain, a twisty or elasticized band, a scarf ring, a fastener, and/or other specially designed element such that the accessory apparatus(es) connect the underlying wireless audio communications device with a user's personal accessory and provide the user with access to one or more earphones and needed wireless audio communications device controls. The accessory apparatuses also include the accessory-style element described in the preceding paragraph, whereby the element encloses and/or otherwise secures the respective subcomponent package, and which accessory-style element may include an earphone docking element. The element may be affixed to a bendable wire and/or other adjustable device, such that the arrangement of the respective subcomponent package and earphone relative to the associated neck-, ear- or eye-based accessory can be manipulated by the user to optimize her access to the earphones and wireless audio communications device controls according to her accessory style, needs and preferences.

There may be more than one type of accessory apparatus used with a given accessory. Certain versions of the accessory apparatuses may integrate the features and functions of the earphone docking elements. The accessory apparatuses may also be used with other suitable audio devices.

For example, an accessory apparatus consisting of a small decorative clip with an integrated earphone docking element may be fastened in an accessible spot on a scarf accessory, and another accessory apparatus consisting of a clip may be used to fasten the respective subcomponent package on the underside of the scarf accessory to provide convenient and discrete access to the respective wireless audio communications device controls. Or both of these functions may be integrated in a single accessory apparatus in one or more of the following form factors and/or shapes: a pin or brooch, a bobby-pin like dip, a clip with interlocking or otherwise connecting teeth, a ring or other shape (closed or open), a clamp, a clasp, a coil, a spiral, a zig zag, an infinity symbol, a knot, a chain, a twisty or elasticized band, a scarf ring, a fastener, or other specially designed jewelry element as described above. The accessory apparatus could include a place to dock the earphone and a slot where the respective subcomponent package can be snapped securely into place for easy and discrete access to the wireless audio communications device controls. The accessory apparatuses may also include devices and means for arranging a scarf accessory in different ways and designs. For example, the accessory apparatus may be a specially designed scarf ring that includes an earphone docking element and a slot for securing the respective subcomponent package to provide convenient access to the respective user controls.

In the case of a user's personal necklace accessory, the accessory apparatuses may be smaller, and/or in a different style to complement the respective accessory look. The accessory apparatus may include an earphone docking element. It may include one or more of the form factors and design features mentioned previously for a scarf accessory, in the appropriate size for the respective necklace accessory, to the end result that the wireless audio communications device and the personal necklace are held together to create an integrated or otherwise complementary accessory look while still providing discrete and convenient access to the wireless audio communications device controls.

The accessory apparatuses may also include a variety of exchangeable decorative earphone tops that can be easily fastened to and removed from the top of the earphones to create alternative fashion looks and styles. The decorative earphone tops may include any number of materials, including real and artificial jewels, crystals, stones, ceramics, plastics and other synthetics, metals and cloth; and may include any number of decorative designs, elements, logos, words, symbols, creatures and shapes. The bottom and sides of these exchangeable decorative earphone tops may be magnetic or magnet-attracting, and the earphones and decorative earphone tops may include other means for easily attaching, detaching and reattaching to each other, including but not limited to snaps, hooks, tracks, grooves, slots, dips, pressure buttons and/or other fastening devices and technologies. In some variations the earphones may also be hidden underneath the accessory apparatus when not in use.

In some variations, the accessory apparatus will be a full necklace-like accessory that will cover all or part of the wireless audio communications device. In such cases, the custom necklace accessory apparatus may include certain design features, elements and materials that facilitate integration with the wireless audio communications device. This may include ways and means for docking and otherwise connecting the wireless audio communications device wire and earphone wires (if any) to the underside of the accessory apparatus. For example, the wireless audio communications device wire may snap or otherwise fasten onto the underside of the accessory apparatus via special tracks, grooves, channels, hooks, clasps, fasteners, depressive buttons, gates, slots, magnetic or magnet-attracting elements; and/or other special elements, materials and means. The earphone wires (if any) may similarly dock or otherwise fasten on the side and/or underside of the accessory apparatus via special tracks, grooves, channels, hooks, clasps, fasteners, magnetic or magnet-attracting elements; and/or other special elements, materials and/or means.

The wireless audio communications device's subcomponent packages and the accessory apparatuses may include design features, elements and materials that facilitate combination with the wireless audio communications device and the associated accessory apparatus or personal accessory. These may include rails, tracks, slots, edges, grooves, buttons, hooks, indentations, depressive buttons, gates and other design features that allow the respective subcomponent package to be easily and securely inserted into an associated accessory apparatus or personal accessory.

The earphone docking elements may be integrated with the wireless audio communications device, and/or may be integrated with a particular accessory apparatus.

The invention may include one or more wireless earphones with an independent power source in addition to or in place of the wired earphones. In other variations, the earphone wires may be detachable from the wireless audio communications device wire and/or the respective earphone. The portion of the earphones that insert into a user's ears may include anti-microbial materials, which materials may or may not be proprietary. The wireless audio communications device may also employ wireless technologies other than Bluetooth, and/or may include RF shielding.

In other variations, the wireless audio communications device wire, earphone wires (if any), earphones, subcomponent packages and various accessory apparatuses may not contain decorative materials or elements, and may not include magnetic or magnet-attracting materials.

In other variations, the wireless audio communications device may include only one wired and/or wireless earphone, and may not include stereo sound.

In other variations, the wireless audio communications device may include one or more wired earphones and one or more wireless earphones.

In other variations, the wireless earphone(s) may be in the form of a decorative ear cuff or other element that is worn on the ear but outside of the ear canal.

In other variations, the wireless audio communications device may include more than one additional speaker assembly in the subcomponent package(s), (additional meaning in addition to the speaker assembly(ies) in the earphone(s)).

In other variations, the wireless audio communications device may not include additional speaker assembly(ies) in the subcomponent package(s), thereby requiring the user to utilize one or more earphones to receive communications from connected devices.

In other variations, the wireless audio communications device may include only one subcomponent package. In other variations, the wireless audio communications device may include more than two accessory-style subcomponent packages. For example, the wireless audio communications device subcomponents may be contained within multiple accessory-style form factors, such as those resembling beads, jewels, stones, decorative shapes, and/or other decorative elements that might be found on a fashion accessory.

In other embodiments, the device wire and subcomponent packages may be combined in one or more integrated, accessory-style form factor(s). In other embodiments, the subcomponent packages and earphone docking elements may be combined in one or more integrated, accessory-style form factor(s). In other embodiments, the device wire, subcomponent packages and earphone docking elements may be combined in one or more integrated, accessory-style form factor(s).

In other variations, the wireless audio communications system may include an additional, smaller wireless audio communications device having a secondary power source that can be conveniently and attractively attached to an accessory such as a pair of sunglasses or eyeglasses, or a hat or hair accessory. In addition or in place of conventional audio communications technology, such embodiments may employ bone conduction technologies, and/or may include accessory-style elements that can be flexibly positioned to facilitate the discrete reception and transmission of audio communications. In other variations, the wireless audio communications system may only include a smaller wireless audio communications device having a primary power source; one or two subcomponent packages; and methods and accessory apparatuses for attaching, detaching and/or otherwise combining the wireless audio communications device with various neck-, head-, eye- and ear-based accessories. For example, the wireless audio communications device could have the style and functionality of a lanyard for use with sunglasses and eyeglasses.

In other variations, the wireless audio communications device and accessory apparatuses, including all related subcomponents, may be designed for a male demographic, or for a younger demographic whether male or female, with associated changes in the invention's design look and style, and the wireless audio communications device's features and functionality.

The invention may also include devices, methods and/or apparatuses for integrating and/l otherwise combining an underlying wireless audio communications device with a hat, headband, hair accessory, ear cuff, earring or other accessory.

The wireless audio communications system may or may not include a mobile phone application, and it may include fewer or additional features and functions. Additional and/or substituted features may include optional integration with other wireless device applications, customized health and fitness tracking, and other notification methods in addition to or in replacement of the haptic notification feature.

The invention may include the accessory apparatuses only, for use with another suitable audio devices. Or it may include the wireless audio communications device only.

The present invention is unique when compared to other known solutions because it allows users to access the convenience and functionality of Bluetooth or other wireless audio technology in the style of a desirably wearable accessory, and it provides the ability to achieve multiple accessory looks and styles with just one wireless audio communications device. The invention provides a unique accessory-style wireless audio communications device that is specially designed to be easily integrated and/or otherwise combined with a variety of accessory elements—including: those designed specifically for the wireless audio communications device as well as certain of a respective user's personal accessories—and it provides the devices, methods and apparatuses to facilitate this integration. For example, the wireless audio communications device wire and subcomponent packages have a very thin profile, with no excess packaging. The subcomponent packages have special design features and elements that facilitate their combination with one or more accessory apparatuses and certain of a user's personal accessories. The earphone wires (if any) and earphone(s) have decorative elements and materials to give them a fashion accessory-style look, and include magnetic, magnet-attracting, and/or other elements and/or materials to allow for discrete docking and/or disguise when not in use. The accessory apparatuses also allow a user to use the wireless audio communications device with certain of her own personal accessories. The earphone docking elements and various accessory apparatuses allow for discrete integration of the wireless audio communications device with the look and style of the associated accessory. A diversity of custom fashion accessories in a variety of neck-, ear- and eye-based styles and form factors, the ability to use certain of her own personal accessories, exchangeable decorative earphone tops, and other accessory apparatuses allow a given user to further vary her accessory styles and looks. In sum, the invention allows a given user to use one wireless audio communications device to create a virtually unlimited variety of fashion accessory styles and looks. This makes the invention unique to other available solutions or inventions in affordability, value, variety, flexibility, individual style, and convenience.

The device portion of the invention is also unique in that it includes one or more speaker assemblies in the body of the device, in addition to the speaker assemblies in the earphone(s). This allows users to receive communications from connected devices to the invention device with and/or without the use of the earphones and provides for more hands-free communications options. It also allows for the invention device to be used as a wearable wireless speaker, such that one or more other individuals, in addition to the respective user, may participate in audio communications to and from the invention device.

The invention is also unique in the comprehensive functionality and features it offers users, and particularly female users. These include haptic notification, audio caller ID and message read-back, voice control, digital assistant access, priority contacts mode, optional integrated fitness tracking, emergency alert features, phone locator, and remote ringer shut-off.

In sum, the invention provides users with mobile, hands-free access to their mobile phones and other connected devices without looking like they are “wearing technology”. And with one wireless audio communications device, a user can achieve multiple accessory looks and styles. A female user can achieve one fashion accessory look with the invention during the day at the office, and move from meeting to meeting without having to carry her mobile phone everywhere and be constantly checking it for messages or otherwise compromise her fashion look and style. While in an important meeting or social setting, she can block all calls and messages except for those she absolutely does not want to miss. If a priority message comes through, she can utilize a decorative earphone in or near her ear and listen to the audio readback of the message. If needed, she can quickly dictate a response from the wireless audio communications device, or step out to make a call—again right from the wireless audio communications device, without ever needing to locate her mobile phone or otherwise call attention to her technology. She has full access to her technology without looking like she's wearing it, or otherwise being compelled to constantly be looking at her mobile device to make sure she doesn't miss an important call or message. If she finds herself waiting for an appointment, she can discretely reach for her attractive fashion accessory and pop a decorative earphone in her ear, or touch the accessory-style wireless earphone already on or in her ear, and listen to music or a podcast, and then quickly reattach the earphone to her accessory, or use voice or touch control to turn it off when her name is called. If she's at a formal social event that evening, she can change the accessory style of her wireless audio communications device to a more formal look by using one or more of the invention's accessory apparatuses, alone or in combination with a personal fashion accessory. If she's at home she can adopt a more casual accessory look and have full hands-free access to her mobile phone and other connected devices while making dinner or carrying out other family and household responsibilities. In all instances she is expressing her unique style and maximizing mobile access, convenience, and personal health and safety.

If a user finds herself in an emergency situation where she would want to quickly and/or discretely call for help or otherwise let selected contacts know her situation and location, she can quickly and easily use touch or voice control from the wireless audio communications device. The potential predator(s) would not even need to know that she's calling for help and/or broadcasting her location.

The present invention is also unique in that it is structurally different from other known accessory-style devices and solutions. It provides for an accessory-style wireless audio communications system, with easy and convenient access to two wired and/or one or more wireless earphones, thus providing options for stereo sound for voice, music and video communications and entertainment. Other variations provide for two wired earphones and an additional accessory-style wireless earphone to maximize the user's audio and accessibility options. If the user wants to use just one earphone for phone communications, she can. Or if she wants to use two earphones for noise cancelling and/or stereo-like sound, she can. More importantly, she can maintain easy access to her mobile phone and other connected devices discretely and fashionably. When not in use, the wireless audio communications device is integrated with or otherwise disguised by an attractive fashion accessory that is customized to the user's unique tastes and style. When needed, the earphones easily detach from the wireless audio communications device and/or accessory, and the controls are easily and discretely accessible. No disassembly or significant hand use and dexterity are required.

The invention's wireless audio communications device is structurally different from other devices and solutions in that it is specifically designed to be combined with or otherwise disguised by a variety of neck-, ear- and eye-based elements, including those specially designed for the wireless audio communications device and certain of a user's personal accessories. The wireless audio communications device's unique features include the combination of the thin profile of the wireless audio communications device wire, subcomponent package(s), earphones and earphone wires (if any); and the design of and/or decorative materials and elements on the device wire, subcomponent packages, earphones and earphone wires, if any. The accessory-style earphone docking elements provide a way for the earphones to conveniently integrate with the design and overall look of an associated fashion accessory when not in use, and allow for the earphones to be easily and discretely detached when needed and reattached when not, with no significant hand dexterity or manipulation. Or, if the wireless audio communications device is worn alone, the earphone docking elements provide a decorative way to keep the earphones out of the way and yet still easily accessible. The design of the earphones to allow for exchangeable Decorative Tops is also unique. The flexibility and convenience provided by two wired earphones and an additional wireless earphone are also unique.

The invention's accessory apparatuses are structurally different from other devices and solutions in the following ways:

Exchangeable decorative earphone tops provide the user with a wide variety of ways to customize the style and look of the earphones.

Magnetic and magnet attracting elements on the wireless audio communications device and earphone wires, if any, provide a way for such earphone wires to be discretely docked when not in use and yet easily accessible when needed. earphone wire docking element(s) on the underside of certain accessory apparatuses provide additional means for any earphone wires to be discretely hidden and yet easily accessible when needed.

The accessory apparatuses provide a way for a given user to combine the wireless audio communications device and other compatible audio devices with certain of her own personal accessories, allowing her to achieve multiple additional accessory looks with the one audio device.

The processes associated with the above-mentioned invention are likewise unique and different from known processes and solutions in that they allow for the integration of the wireless audio communications device with any number of fashion accessories, including those custom accessory apparatuses specially designed for the wireless audio communications device, as well as certain of the user's own personal accessories. The wireless audio communications device attaches easily to a given accessory apparatus and the earphones attach to the respective earphone docking element. The wireless audio communications device controls are easily accessible from the underneath and/or sides. When a user is using a personal accessory, the accessory apparatuses provide creative and decorative ways for the wireless audio communications device to be combined with the personal accessory, including a place for the earphones to dock and a place for the subcomponent package(s) to be hidden or otherwise disguised yet still accessible.

Among other things, it is an objective of the present invention to provide the devices, methods and apparatuses for integrating and/or otherwise combining the desirable features and functionality of a wireless audio communications device with the look of a desirable fashion accessory. It is furthermore the objective to provide the devices, methods and apparatuses to allow users, and in particular female users, to achieve multiple accessory looks and styles with just one audio device in a way that is affordable, flexible, creative and adaptable—such that every user can maintain discrete hands-free access to her mobile phone and other connected devices without having to compromise her unique sense of style, and/or break her budget. It is still further the objective of the present invention to combine a number of features and functions that women use and/or could benefit from in one convenient wearable audio communications system—including: voice control of and access to her mobile device; voice control of and access to various digital assistants; priority contacts mode and customizable communications protocols; emergency alert features; ringer shut-off; haptic notification with audio caller ID and message readback; fitness tracking; and/or external application integration and access.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the wireless audio communications device with earphone docking elements, with one earphone docked and one earphone undocked.

FIG. 2 shows the wireless audio communications device in FIG. 1 integrated with a custom necklace accessory apparatus.

FIG. 3 shows the wireless audio communications device+necklace accessory apparatus shown in FIG. 2, with both earphones docked.

FIG. 4 shows a three-dimensional side view of a scarf ring accessory apparatus, with the device open to show the integrated earphone docking element and the slot for the respective subcomponent package.

FIG. 5 shows a top view of the accessory apparatus shown in FIG. 4.

### DETAILED DESCRIPTION OF THE INVENTION

The invention is directed to the devices, methods and apparatuses for integrating or otherwise combining a wireless audio communications device with a fashion-style accessory such as a necklace or scarf, including the ability to create multiple fashion looks and styles with the one audio communications device.

In its most complete version, the present invention includes all of the devices, methods and apparatuses needed to combine the functionality and convenience of a Bluetooth or other wireless audio communications device with the look of an attractive fashion accessory. This includes a specially designed wireless audio communications device and the accessory apparatuses needed to facilitate the integration of the wireless audio communications device with various neck-, ear- and eye-based accessories. The accessory apparatuses include various custom necklace, scarf, ear-based and eye-based accessory apparatuses designed specifically for exchangeable combination with the wireless audio communications device; various exchangeable decorative earphone tops and cuffs, which can be easily attached and detached from the earphone(s) to create alternative accessory styles and looks; and various accessory apparatuses, which can be used to combine the wireless audio communications device with other accessory apparatuses and/or a user's own personal neck-, ear- and eye-based accessories.

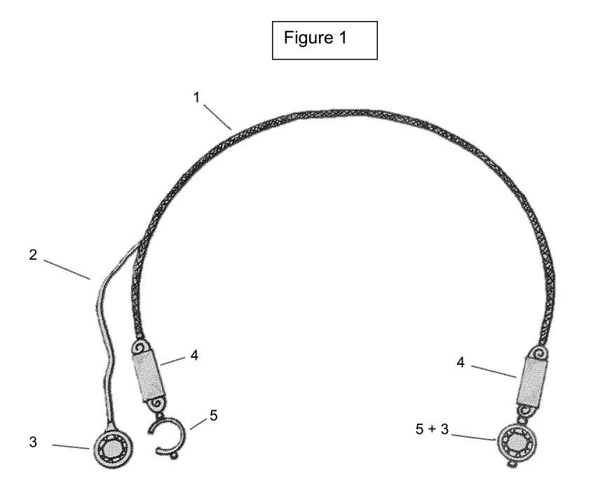

FIG. 1 shows a particular version of a neck-based Bluetooth wireless audio communications device designed to be combined with custom necklace and scarf accessory apparatuses, and with certain of a user's own personal accessories. In this particular embodiment, the wireless audio communications device is shown with: a wireless audio communications device wire 1 that is between approximately 24 inches and 32 inches in length, connected on each end to an accessory-style subcomponent package 4; two earphone wires 2, each between approximately 8 inches and 16 inches in length, that are connected to the wireless audio communications device wire 1 at or near the middle point; two earphones 3, that are each connected to the end of the respective earphone wire 2; and two earphone docking elements 5, that are each connected to the bottom of the respective subcomponent package 4. The subcomponent packages 4 include the hardware components, power support, software and user controls necessary to support the wireless audio communications device's functionality and features, including access to and control of the user's connected Bluetooth-enabled devices (e.g., mobile phones, smart speakers, tablets, computers and other streaming devices).

The size, style and design of the wireless audio communications device shown in FIG. 1 allow for discrete, low-profile integration with specially designed custom necklace and scarf accessory apparatuses, as well as with certain of the user's own personal fashion accessories. The wireless audio communications device wire 1 is thin and flexible, with no superfluous packaging, and is covered with decorative materials to create a jewelry-like look. In this particular embodiment, it includes magnet-attracting elements to facilitate docking with the earphone wires 2 when the latter are not in use. The earphone wires 2 are also thin and covered with decorative materials to create a jewelry-style look. In this particular embodiment, they include magnetic elements to facilitate docking with the wireless audio communications device wire 1 or certain accessory apparatuses (not shown) when not in use. The earphones 3 are also jewelry-like in color, style and materials. In this particular embodiment, they have decorative, magnet-attracting tops to facilitate optional combination with exchangeable decorative earphone tops (not shown). In this particular embodiment, the sides of the earphones 3 also contain magnetic design elements (not shown) to facilitate discrete integration with the earphone docking elements 6 when the earphones 3 are not in use. FIG. 1 shows the earphone 3 and earphone wire 2 on the left undocked for use, and the earphone 3 and earphone wire 2 on the right docked with the earphone docking element 5 and wireless audio communications device wire 1, respectively. The subcomponent packages 4 are also jewelry-like in color, style and materials.

In other embodiments of the wireless audio communications device shown in FIG. 1, one or both of the earphones 3 may be wireless, and/or may be of a different design, size and/or shape—for example, the earphones 3 may be in the form of another geometric shape, or a flower, decorative knot or other object (not shown). Alternatively, there may be two wired earphones and an additional wireless earphone in the style of an attractive ear-based accessory such as a cuff or ring. The earphone docking elements 5 and/or the subcomponent packages 4 may also be of a different design, size and/or shape (not shown). The wireless audio communications device wire 1 and earphone wires 2 (if any) may be longer or shorter in other embodiments of the invention (not shown), or placed in different locations relative to the other wireless audio communications device subcomponents (not shown). Alternative means of docking any earphone wires to the wireless audio communications device wire may also be used, including, for example, an easy-release gate, channel or clasp.

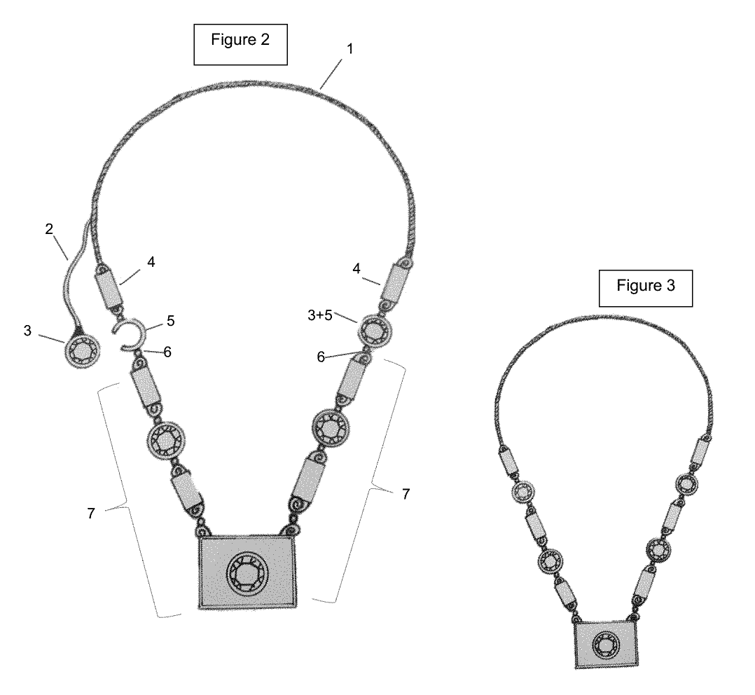

FIG. 2 and FIG. 3 show a particular version of a custom necklace accessory apparatus 7, combined with the wireless audio communications device shown in FIG. 1. The custom necklace accessory apparatus 7 connects to the wireless audio communications device via a clasp 6 on the bottom of each earphone docking element 5 to form the complete necklace-like accessory shown in FIG. 2 and FIG. 3. When one or both of the earphones 3 are not in use, the respective earphone wire 2 attaches to the wireless audio communications device wire 1 via a combination of magnetic elements on the earphone wire 2 and magnet-attracting elements on the wireless audio communications device wire 1. The magnetic sides of the earphones 3 dock on the respective earphone docking element 6 with the decorative earphone tops facing upward as part of the overall custom necklace accessory apparatus 7 design and look. The clasps 6 on the ends of the custom necklace accessory apparatus 7 allow for easy front removal and attachment of the combined wireless audio communications device+accessory apparatus. In other embodiments, exchangeable decorative earphone tops (not shown) may be added to the earphones 3 to create an alternative accessory look.

The wireless audio communications device hardware, software and wireless audio communications device user interface allow for haptic notification, voice control of connected device and headset features, digital assistant access, audio caller ID and message readback, priority contacts mode, emergency alert features, fitness tracking, external application integration, ringer shut-off, phone locator and out-of-range alert.

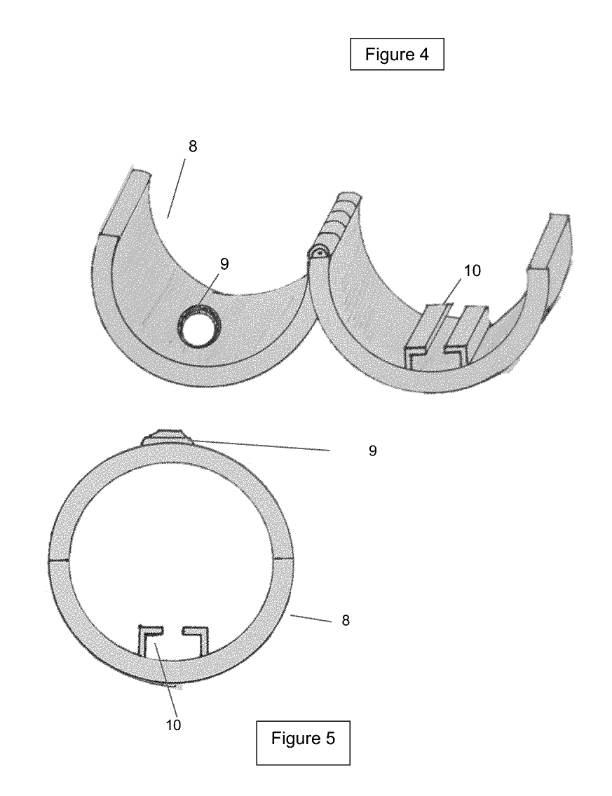

FIG. 4 and FIG. 5 show a particular version of an accessory apparatus in the style of a scarf ring that allows the user to integrate the wireless audio communications device shown in FIG. 1 with a personal scarf accessory. FIG. 4 shows a three-dimensional open view of the scarf ring accessory apparatus, with the special earphone docking element 9 and the subcomponent package slot 10. The user can place the wireless audio communications device shown in FIG. 1 around her neck, then fasten the scarf ring accessory apparatus 8 around her personal scarf accessory and arrange the latter as desired. She can then dock the earphone 3 in the special earphone docking element 9, and slide the subcomponent package 4 into the special slot 10. This allows her to have easy access to at least one earphone and one set of wireless audio communications device controls while wearing her scarf. If she wishes to have the same access to the other earphone and controls, she can simply use another accessory apparatus—either like the one shown in FIG. 5 or another style (not shown).

FIG. 5 shows a top view of the scarf ring accessory apparatus shown in FIG. 4.

In other embodiments of the scarf ring accessory apparatus (not shown), the earphone docking element 9 will be a C-shape or half-circle or other -geometric shape on the edge of the accessory apparatus 8. The device for securing the respective subcomponent package 10 could also take another form or design.

The accessory apparatus could also take a variety of other shapes and designs (not shown), including but not limited to a pin or brooch, a bobby-pin like clip, a dip with interlocking or otherwise connecting teeth, a filigree ring or other shape (closed or open), a clamp, a clasp, a coil, a spiral, a zig-zag, an infinity symbol, a knot, a chain, a twisty or elasticized band, a fastener, or other specially designed jewelry element. The accessory apparatus could also be made of a wide variety of materials, including but not limited to various metals, fabric and woven materials, beads, ceramics, plastics and other synthetics, glass, jewels or jeweled materials, paper, and any other materials from which jewelry-type accessories can be made.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A fashion accessory-style wireless audio communications device comprising:
two or more fashion accessory-style subcomponent packages containing the transceiver(s), circuit board(s), module(s), sensor(s), speaker(s), microphone(s), other hardware, other components, and all associated firmware, software and materials needed for the wireless audio communications device's operations, features and functionality;
fashion accessory-style covered wire connecting the subcomponent packages;
two fashion-accessory style earphones connected to the wireless audio communications device via two secondary fashion-accessory style covered wires;
two fashion accessory-style earphone docking elements, each having on the one end the means to be permanently attached to the unconnected end of a subcomponent package, and each having on the other end the means to be removably connected to the opposite earphone docking element.

2. A fashion accessory and wireless audio communications system comprising the wireless audio communications device of claim 1; and one or more of the following:
one or more fashion accessory-style necklace elements that can be removably connected to the unconnected ends of each accessory-style earphone docking element;
one or more fashion accessory-style scarf elements that can be removably attached to the wireless audio communications device;
an accessory apparatus comprising: an aperture through which a scarf accessory can be threaded in a decorative or otherwise useful manner a slot, clip or other device for securing one or more of the subcomponent packages for the wireless audio communications device; and one or more accessory-style earphone docking elements.

3. The wireless audio communications device of claim 1, wherein the fashion-accessory style earphone docking elements are instead attached to or otherwise positioned above the respective end subcomponent package.

4. The accessory and wireless audio communications system of claim 2, wherein the fashion-accessory style earphone docking elements are instead attached to or otherwise positioned above the respective end subcomponent package.

5. The wireless audio communications device of claim 1, wherein the two accessory-style earphones are instead wirelessly connected to the main wireless audio communications device, which is the primary power source,
wherein each wireless earphone is configured to receive power from a secondary power source when decoupled from the primary power source, and
wherein each wireless earphone is configured to charge its secondary power source using the first power source when the wireless earphone is connected to the primary power source.

6. The accessory and wireless audio communications system of claim 2, wherein the two accessory-style earphones are instead wirelessly connected to the main wireless audio communications device, which is the primary power source,
wherein each wireless earphone is configured to receive power from a secondary power source when decoupled from the primary power source, and
wherein each wireless earphone is configured to charge its secondary power source using the primary power source when the wireless earphone is connected to the primary power source.

7. The accessory-style wireless audio communications device of claim 3, wherein the two fashion accessory-style earphones are instead wirelessly connected to the main wireless audio communications device, which is the primary power source,
wherein each wireless earphone is configured to receive power from a secondary power source when decoupled from the primary power source, and
wherein each wireless earphone is configured to charge its secondary power source using the first power source when the wireless earphone is connected to the primary power source.

8. The fashion accessory-style wireless audio communications device of claim 4, wherein the two accessory-style earphones are instead wirelessly connected to the main wireless audio communications device, which is the primary power source,
wherein each wireless earphone is configured to receive power from a secondary power source when decoupled from the primary wireless audio communications device, and
wherein each wireless earphone is configured to charge its secondary power source using the first power source when the wireless earphone is connected to the primary power source.

9. The accessory and wireless audio communications system of claim 2, having a primary power source; and an additional accessory-style wireless earphone having a secondary power source,
wherein the wireless earphone is configured to receive power from its secondary power source when decoupled from the primary power source, and
wherein the wireless earphone is configured to charge its secondary power source using the primary power source when the wireless earphone is connected to the primary power source.

10. The accessory and wireless audio communications system of claim 4, having a primary power source; and an additional accessory-style wireless earphone having a secondary power source,
wherein the wireless earphone is configured to receive power from its secondary power source when decoupled from the primary power source, and
wherein the wireless earphone is configured to charge its secondary power source using the primary power source when the wireless earphone is connected to the primary power source.

11. The accessory and wireless audio communications system of claim 6, having a primary power source; and an additional accessory-style wireless earphone having a secondary power source,
wherein the wireless earphone is configured to receive power from its secondary power source when decoupled from the primary power source, and
wherein the wireless earphone is configured to charge its secondary power source using the primary power source when the wireless earphone is connected to the primary power source.

12. The accessory and wireless audio communications system of claim 8, having a primary power source; and an additional accessory-style wireless earphone having a secondary power source,
wherein the wireless earphone is configured to receive power from its secondary power source when decoupled from the primary power source, and
wherein the wireless earphone is configured to charge its secondary power source using the primary power source when the wireless earphone is connected to the primary power source.
